(19) United States
(12) Patent Application Publication
(10) Pub. No.: US 2022/0396005 A1
(43) Pub. Date: Dec. 15, 2022

(54) METHOD FOR PRODUCING A REINFORCED CONCRETE COMPONENT, REINFORCED CONCRETE COMPONENT AND PRODUCTION SYSTEM

(71) Applicant: AEDITIVE GMBH, Norderstedt (DE)

(72) Inventors: Hendrik Lindemann, Hamburg (DE); Roman Gerbers, Hamburg (DE); Niklas Nolte, Hamburg (DE)

(21) Appl. No.: 17/777,146

(22) PCT Filed: Nov. 17, 2020
(86) PCT No.: PCT/EP2020/082343

§ 371 Date: May 16, 2022

(30) Foreign Application Priority Data
Nov. 18, 2019 (DE) 10 2019 131 051.2

(51) Int. Cl. B28B 1/00; B28B 19/00; B28B 23/00; B28B 23/02

(52) U.S. Cl. CPC B28B 1/001; B28B 19/0015; B28B 23/005; B28B 23/02; B33Y 10/00

(57) ABSTRACT

The invention relates to a method for manufacturing a reinforced concrete component (1, 1′), in particular a generatively produced reinforced concrete component (1, 1′), a reinforced concrete component and a manufacturing system for manufacturing a reinforced concrete component. In particular, the invention relates to a method for manufacturing a reinforced concrete component (1, 1′), comprising: creating a first concrete layer (20) and a second concrete layer (22) with a generative method, preferably with a shotcrete method, arranging a positioning element (100, 102, 104, 110, 120, 122, 124, 126, 128, 130) for fixing a reinforcement unit (200), wherein the positioning element is arranged with a supporting section (106) between the first concrete layer (20) and the second concrete layer (22) and protrudes with a fastening section (108) from the first concrete layer and from the second concrete layer (22), arranging at least one reinforcement unit (200) for reinforcing the concrete component (1, 1′) on the positioning element.

The invention relates to a method for manufacturing a reinforced concrete component, in particular a generatively produced reinforced concrete component, a reinforced concrete component produced in particular by a generative method, and a manufacturing system for manufacturing a reinforced concrete component, in particular a generatively produced concrete component.

Reinforced concrete components are known in principle. To produce a reinforced concrete component or a reinforced concrete section, reinforcement is first erected, usually in the form of a reinforcement cage. To ensure that the individual reinforcing bars are in a predefined position in the finished concrete part and do not essentially change their position during concreting, the individual reinforcing bars are usually connected to each other with a binding wire. This fastening by means of the binding wire is also referred to as wire twisting.

A formwork is provided around the reinforcement cage, which usually has the outer contour of the concrete component to be produced as its inner contour. When the concrete is poured in, the reinforcement cage is essentially completely encased by the concrete. Usually, a minimum thickness of concrete must be provided between the individual components of the reinforcement cage and the outer surface of the concrete component so that the reinforcement cage, which is usually made of steel, is protected from corrosion by the concrete. To ensure this minimum distance, spacers are usually installed between the reinforcement and the formwork, made of plastic or concrete, for example. It is well known among experts not to design concrete components in such a way that components of the reinforcement protrude from the concrete, as these can corrode and the corrosion can reach the inside of the concrete component, where it reduces the strength of the reinforcement.

Reinforced concrete components have the advantage that the tensile and compressive forces are transferred by different materials. Concrete has advantageous material properties for absorbing compressive forces, but the material properties for absorbing tensile forces are only suitable to a limited extent. In reinforced concrete components, the reinforcement takes over the transfer of the tensile forces. As a result, a reinforced concrete component can advantageously absorb compressive forces through the concrete and tensile forces through the reinforcement, which is usually made of steel.

In the prior art, it is known to use a steel reinforcement for concrete components that are subjected to different load cases, in particular tensile and compressive forces. To date, reinforced concrete components have essentially been produced conventionally, i.e. first a formwork is erected, reinforcement in the form of a reinforcement cage is produced and then the space formed by the formwork in which the reinforcement cage is located is filled with concrete.

Generative manufacturing methods are used industrially in the production of plastic parts and metal components. Generative manufacturing, also known as 3D printing, for concrete components is essentially still at the development stage. Generative methods for concrete components include methods based on extrusion, or on selective bonding, and other alternative concrete deposition methods that apply concrete layer by layer. In addition, there are methods in which the formwork is produced generatively. Another method with significant advantages over the method mentioned in the previous is the spraying of concrete.

One advantage of generative methods for the production of concrete components is that these methods can basically be automated. However, the generative construction of concrete components makes it difficult to use the classic reinforcement principle with a reinforcement cage that is filled with concrete after insertion into a formwork. Since the reinforcement in particular is usually not designed to be slack, but must exhibit stress according to applicable standards, the reinforcement of generatively produced concrete components presents a challenge. Furthermore, methods exist that provide for automated concrete application and manual arrangement of the reinforcement. In addition, there are concepts in which the geometry of the concrete component is specifically designed for the arrangement of reinforcement.

These methods have the disadvantage that they require either a high manual effort and/or a modification of the component. Another disadvantage of many existing concepts is that the reinforcement is essentially not held in the predefined position mentioned in the previous, so that these components do not conform to standards. In particular, it is a disadvantage of the previously known methods that the reinforcement can essentially only be inserted between the concrete layers and can thus only act in one plane.

In the production of reinforced concrete components, it is also necessary to achieve the desired strength in terms of tensile and compressive forces. In addition, the components must be manufactured at low cost in order to meet the high requirements for cost-effectiveness in the construction industry.

It is an object of the invention to provide a method for manufacturing a reinforced concrete component, in particular a generatively produced reinforced concrete component, a reinforced concrete component that is produced in particular by a generative method, and a manufacturing system for manufacturing a reinforced concrete component, in particular a generatively produced concrete component, which reduce or eliminate one or more of the disadvantages mentioned. In particular, it is an object of the invention to provide a solution that enables automated generative manufacturing, in particular by a shotcrete method. It is at least one object of the invention to provide an alternative solution for providing a generatively manufactured reinforced concrete component.

According to a first aspect, this object is solved by a method for manufacturing a reinforced concrete component, comprising: manufacturing a first concrete layer and a second concrete layer with a generative method, preferably with a shotcrete method, in particular with a shotcrete pressure method, arranging a positioning element for arranging, in particular for fixing, a reinforcement unit, wherein the positioning element is arranged with a supporting section between the first concrete layer and the second concrete layer and protrudes with a fastening section from the first concrete layer and from the second concrete layer, arranging at least one reinforcement unit for reinforcing the concrete component at the positioning element, and preferably manufacturing a concrete cover layer at the first concrete layer and the second concrete layer such that the reinforcement unit is substantially covered with concrete.

The invention is based on the realization that the automated production of reinforced concrete components is only possible at great expense and is not an economical solution in many cases. The inventors have found that with the multi-stage method described in the foregoing, automated production of reinforced concrete components is possible. This enables efficient series production of components. Furthermore, an efficient production of individual components, especially close to the construction site, can be envisaged. Furthermore, the inventors have surprisingly found that the reinforcement produced in this way, when used in a generative manufacturing method, enables a concrete component of better quality, which is moreover more reproducible.

The first concrete layer and the second concrete layer are produced using the generative method. A generative method is characterized by the fact that the first concrete layer and the second concrete layer can be produced automatically and without formwork. It is particularly preferred that the generative method is a shotcrete method, preferably a concrete spay pressure method.

In the shotcrete method, the nozzle from which the concrete emerges is usually spaced from the concrete layer to be produced. The concrete is usually accelerated by means of compressed air so that the concrete is torn apart. This distinguishes the shotcrete method in particular from extrusion methods, in which the concrete is rather deposited with a slight contact pressure and there is usually no significant distance between the extrusion tool and the concrete bead to be applied.

The positioning element is arranged in sections between the first concrete layer and the second concrete layer. Between the two concrete layers means in particular that the positioning element is arranged between a first boundary layer of the first concrete layer facing away from the second concrete layer and a second boundary layer of the second concrete layer facing away from the first concrete layer. Furthermore, between the concrete layers may mean that the positioning element is in contact with the first concrete layer and with the second concrete layer.

The positioning element protrudes with the fastening section from the first concrete layer and from the second concrete layer. Usually, the first concrete layer and the second concrete layer have a horizontal, planar extension and, orthogonal to this planar extension, a thickness that is usually vertically oriented. The relationships described above and below are explained for the normal case of horizontally oriented concrete layers. However, any other orientations are also possible, so that the terms horizontal and vertical are not necessarily restrictive, but merely define an orientation to each other.

The protrusion of the positioning element from the first concrete layer and the second concrete layer is preferably horizontal. The positioning element has at least the supporting section, which is arranged between the concrete layers and thus covered, and the fastening section, which protrudes. Alternatively, and as will be explained in more detail below, the positioning member may also comprise two fastening sections such that, for example, a first fastening section protrudes on a first side of the first concrete layer and the second concrete layer and a second fastening section protrudes on a second side, different from the first side, of the first concrete layer and the second concrete layer. As a result, a reinforcement unit can be arranged on both sides.

The fastening section is arranged and configured in such a way that a reinforcement unit can be arranged on it. For example, the positioning element can have a section that is bent vertically upwards so that the reinforcement unit can be arranged, in particular suspended, on this section. The fastening section can also rise vertically, be corrugated or have depressions.

The positioning element as such is usually not part of the reinforcement. The positioning element essentially serves to arrange the at least one reinforcement unit. In particular, it is preferred that during manufacture the positioning element is horizontally protruding and the reinforcement unit is suspended from the at least one positioning element, preferably from two or more positioning elements.

The reinforcement unit is configured to reinforce a concrete component. For this purpose, the reinforcement unit preferably has reinforcement elements. The reinforcement elements can be arranged in different ways within the reinforcement unit and can also have different geometries and dimensions. It is preferred that the reinforcement unit and/or the reinforcement elements consist of steel or comprise steel. It is preferred that the reinforcement unit and/or the reinforcement elements may further comprise carbon fibers, glass fibers, natural fibers and/or bamboo and/or comprise carbon fibers, glass fibers, natural fibers and/or bamboo and may further preferably comprise a matrix material.

The reinforcing elements can be rod-shaped with a substantially round, rectangular and/or polygonal cross-section, whereby it is particularly preferred that the reinforcing elements consist of or comprise carbon fiber and/or glass fiber reinforced plastic. In addition, the reinforcing elements may have a planar design. Furthermore, it is preferred that the reinforcing elements comprise slack fabrics and/or scrim mats, in particular of carbon fibers and/or glass fibers. The carbon fibers and the glass fibers may be present as continuous fibers and/or as fiber bundles.

In order to form a structural reinforcement of the concrete component, the concrete cover layer is preferably created on the first concrete layer and on the second concrete layer. This is done in such a way that the reinforcement unit is essentially covered by the concrete cover layer. Preferably, the concrete cover layer has a planar extension oriented orthogonally to the planar extension of the first concrete layer and/or the second concrete layer. Preferably, a vector of the concrete cover layer is substantially parallel to the thickness of the first concrete layer and/or the second concrete layer.

In particular, it is preferred that the positioning element has a further fastening section on a further side of the concrete component, a further reinforcement unit is arranged there and a concrete cover layer is arranged there in an analogous manner.

In particular, it is preferred that the method comprises the production of a plurality of first concrete layers and second concrete layers, wherein at least one positioning element is arranged between each two adjacent concrete layers, preferably two or more positioning elements. In a preferred embodiment of the method, it is provided that first the first concrete layer is produced, the positioning element is arranged at, in particular on, the first concrete layer, and the second concrete layer is produced at, in particular on, the first concrete layer and at, in particular on, the positioning element in such a way that the positioning element is arranged between the first concrete layer and the second concrete layer.

This sequence of layer production and arrangement of the positioning element enables automation of the method in an advantageous manner. In particular, the first concrete layer can be produced with a concrete spraying nozzle using a first handling unit, the positioning element can be arranged using a second handling unit with a corresponding tool, and then the second concrete layer can be produced again using the first handling unit. The at least partial parallelization of these steps enables an efficient method.

In a further preferred embodiment of the method, it is provided that the reinforcement unit is provided as a prefabricated reinforcement unit with a plurality of interconnected reinforcement elements.

The prefabricated reinforcement unit can be configured in particular as a reinforcement mat. The reinforcement mat comprises in particular a plurality of parallel first reinforcement elements and a plurality of parallel second reinforcement elements arranged orthogonally to the first reinforcement elements. Such prefabricated reinforcement units are inexpensive to provide, easy to handle and, moreover, advantageously arrangeable on the at least one positioning element. Thus, there is the possibility for generative production of a low-cost concrete component comprising a reinforcement.

In a further preferred embodiment of the method, it is provided that a composite layer is applied to the first concrete layer and the second concrete layer in such a way that the reinforcement unit is positioned at least in sections by means of the composite layer. This positioning is to be understood in particular as holding in one position. In particular, this prevents cavities from forming between the reinforcement unit and the concrete layers.

The composite layer positions the reinforcement unit relative to the first concrete layer and the second concrete layer. As a result, the concrete cover layer can be applied without the risk of shifting the position of the reinforcement unit. Furthermore, the concrete component can also be used without the concrete cover layer in advantageous.

Another preferred embodiment is characterized in that the reinforcement unit has a vertical reinforcement element, the method comprising the step of: arranging the vertical reinforcement element with a coupling section, in particular with a fastening hook, on the positioning element.

In another preferred embodiment, the reinforcement unit is provided with a horizontal reinforcement element, the method comprising the step of: arranging the horizontal reinforcement element on the positioning element, preferably in vertical direction on the positioning element.

Furthermore, it may be preferred that first the vertical reinforcement element is arranged on the positioning element and then the horizontal reinforcement element is arranged on the positioning element in such a way that the vertical reinforcement element is arranged at least in sections, in particular with the coupling section, between the horizontal reinforcement element and the first concrete layer and/or the second concrete layer and/or the composite layer. In particular, it is preferred that these are arranged in such a way that the vertical reinforcement element is clamped.

The vertical reinforcement element is preferably arranged in such a way that its main direction of extension is essentially vertical. However, with appropriate arrangement and appropriate application of the method, the vertical reinforcement element can also be arranged horizontally. It is preferred that the vertical reinforcement element is hooked to the positioning element with the coupling section. Thus, an automated arrangement of the vertical reinforcement element can be made possible. The vertical reinforcement element is arranged with the coupling section in such a way that the vertical reinforcement element is coupled to the reinforcement element by means of the coupling section.

The horizontal reinforcement element is preferably arranged on the positioning element in such a way that it is aligned with its main extension direction horizontal. In particular, it is preferred that at least two positioning elements are arranged that are spaced apart in the horizontal direction and arranged at the same height in the vertical direction, and the horizontal reinforcement element is placed on the two positioning elements. Thus, this would be arranged on the positioning element in the vertical direction.

It is preferred that first the vertical reinforcement element is arranged on the positioning element and then the horizontal reinforcement element is arranged on the positioning element. As a result, the vertical reinforcement element is positioned by the horizontal reinforcement element by pushing it through the horizontal reinforcement element in the direction of the first concrete layer and the second concrete layer. It is particularly preferred that before the reinforcement unit is arranged, the composite layer is arranged, which is substantially not yet solidified when the reinforcement unit is arranged, so that when the reinforcement unit is arranged, a bonding effect occurs between this layer and the reinforcement unit. In particular, the composite layer is arranged and formed in such a way that it causes a coupling between the reinforcement unit and the first concrete layer and/or the second concrete layer.

By arranging vertical reinforcement elements and horizontal reinforcement elements, an individually formed reinforcement unit can be provided. In particular, this allows a highly automated method to be implemented, whereby flexible reinforcement can still be formed in terms of its geometry. In particular, complex geometries can be formed by means of preformed, vertical and/or horizontal reinforcement elements. In addition, a fixed reinforcement with predefined positioning of the reinforcement elements can be made possible by a resulting clamping, in particular in the area of the positioning element.

In another preferred embodiment, the reinforcement unit is provided with a corner reinforcement element, the method comprising the step of: arranging the corner reinforcement element in a corner area adjacent to a corner of the concrete component such that a first section of the corner reinforcement element is arranged on a first side of the concrete component at a first positioning element, and that a second section of the corner reinforcement element is arranged on a second side of the concrete component, different from and adjacent to the first side, at a second positioning element.

The corner area includes the first side and the second side of the concrete component. The first side and the second side are also angled 90° to each other in the case of a 90° corner. The first side and the second side may also be at any angle to each other, for example such that they include a 120° angle. To enable appropriate strength of a concrete component in the corner area, this must also be reinforced. For the corner reinforcement element, the corner area has a first positioning element on the first side and a second positioning element on the second side. The positioning elements essentially act as supports for the corner reinforcement element.

The arrangement of the corner reinforcement element on the first positioning element and/or on the second positioning element means in particular that it rests on the first positioning element and/or on the second positioning element.

In another preferred embodiment, the method is provided to comprise the step of: contour-matching preforming the horizontal reinforcement element and/or the vertical reinforcement element, preferably the horizontal reinforcement element and/or the vertical reinforcement element having a radius due to the contour-matching preforming.

In this embodiment, for example, the system for carrying out the method can have a unit for contour-matched preforming of the horizontal reinforcement element and/or the vertical reinforcement element. This means that the contour-matched reinforcement element can be produced before the time when it is needed to reinforce the concrete component.

Alternatively or additionally, preformed horizontal and/or vertical reinforcement elements can also be provided. Therefore, the method preferably comprises the step of: providing preformed horizontal and/or vertical reinforcement elements having, for example, a radius.

A further preferred embodiment of the method is characterized in that the method comprises the step of: finishing the concrete cover layer for smoothing and/or structuring. By finishing the concrete cover layer, the concrete component produced is ready for installation and may not require any post-processing after the intended use of the concrete component.

According to a further aspect, the above-mentioned object is solved by a reinforced concrete component comprising a first concrete layer and a second concrete layer which are produced by a generative method, preferably by a shotcrete method, in particular by a concrete spray pressure method, a positioning element for arranging, in particular for fixing, a reinforcement unit, which is arranged with a supporting section between the first concrete layer and the second concrete layer and which protrudes with a fastening section from the first concrete layer and from the second concrete layer, a reinforcement unit arranged on the positioning element for reinforcing the concrete component, and preferably a concrete cover layer arranged on the first concrete layer and the second concrete layer in such a way that the reinforcement unit is substantially covered by the concrete cover layer.

The advantages mentioned in the foregoing regarding the method for manufacturing the reinforced concrete component apply substantially analogously to the reinforced concrete component according to the further aspect. The aforementioned features and advantages thus apply analogously to the reinforced concrete component with the corresponding adaptations. In particular, the reinforced concrete component is characterized by a high geometric flexibility, since essentially any geometries can be produced by means of the generative method.

Furthermore, by means of the flexible reinforcement approach, this flexible geometry can also be produced as a reinforced concrete component. Furthermore, this method can be automated, so that the method requires low manpower. In addition, high quality can be achieved due to the high automation of the method.

In a preferred embodiment of the reinforced concrete component, it is designated that the reinforcement unit has a horizontal reinforcement element that preferably rests on the positioning element in the vertical direction. Furthermore, it is preferred that the reinforcement unit comprises a vertical reinforcement element which is arranged with a coupling section, in particular with a fastening hook, on the positioning element. A further preferred embodiment provides that the vertical reinforcement element is arranged at least in sections between the first concrete layer and/or the second concrete layer and/or a composite layer and the horizontal reinforcement element, wherein furthermore preferably the positioning element, the vertical reinforcement element and the horizontal reinforcement element are arranged and configured such that a clamping acts between them.

Furthermore, it is preferred that the reinforcement unit comprises a corner reinforcement element, wherein the corner reinforcement element is arranged in a corner area adjacent to a corner of the concrete component in such a way that a first section of the corner reinforcement element is arranged, in particular rests, on a first positioning element on a first side of the concrete component, and that a second section of the corner reinforcement element is arranged, in particular rests, on a second positioning element on a second side of the concrete component, which is different from and adjacent to the first side.

A further preferred embodiment of the reinforced concrete component provides that the fastening section of the positioning member is hook-shaped and/or loop-shaped, and/or the positioning member protrudes with a first fastening section on a first side of the concrete component and with a second fastening section on a second side of the concrete component opposite to the first side, and/or the positioning member has a main extension direction oriented substantially orthogonal to a layer thickness of the first concrete layer and/or the second concrete layer.

Furthermore, it is preferred that the horizontal reinforcement element and/or the vertical reinforcement element is/are configured to match the contour and, in particular, has/have a curved course. Furthermore, it may be preferred that the horizontal reinforcement element and/or the vertical reinforcement element is/are rod-shaped and preferably consists of steel or comprises steel.

In a further preferred embodiment, the reinforced concrete component comprises a shear reinforcement, in particular a strap reinforcement. The strap reinforcement preferably comprises a first strap with a vertically downwardly open opening and a second strap with a vertically upwardly open opening, the first concrete layer and the second concrete layer being enclosed by the straps at least in sections, preferably completely.

According to a further aspect, the above-mentioned problem is solved by a reinforcement structure for a reinforced concrete component, comprising a positioning element for arranging, in particular for fixing, a reinforcement unit, which can be arranged with a supporting section between a first concrete layer and a second concrete layer, which are produced by a generative method, preferably by a shotcrete method, and protrudes with a fastening section from the first concrete layer and from the second concrete layer, and a reinforcement unit arranged on the positioning element for reinforcing the concrete component. The reinforcement unit is in particular arranged, preferably fastened, to the fastening section.

A preferred embodiment of the reinforcement structure is characterized in that the reinforcement unit comprises a horizontal reinforcement element which preferably rests on the positioning element in the vertical direction, and/or the reinforcement unit comprises a vertical reinforcement element which is arranged with a coupling section, in particular with a fastening hook, on the positioning element, and/or preferably the vertical reinforcement element can be arranged at least in sections between the first concrete layer and/or the second concrete layer and/or a composite layer and the horizontal reinforcement element, wherein furthermore preferably the positioning element, the vertical reinforcement element and the horizontal reinforcement element are arranged and formed in such a way that a clamping acts or can act between them.

According to a further aspect, the above-mentioned object is solved by a manufacturing system for manufacturing a reinforced concrete component, comprising means, in particular a shotcrete nozzle, for manufacturing a first concrete layer and a second concrete layer by a generative method, preferably by a shotcrete method, a handling system being arranged and adapted to a positioning element for fixing a reinforcement unit between the first concrete layer and the second concrete layer, a reinforcement unit being arranged on the positioning element, and preferably the means, in particular the shotcrete nozzle, being adapted to produce a concrete cover layer on the first concrete layer and the second concrete layer in such a way that the reinforcement unit is substantially covered with concrete.

A preferred embodiment of the manufacturing system provides that the handling system has a first handling unit and a second handling unit, the first handling unit comprising the means, in particular the shotcrete nozzle, for manufacturing the first concrete layer, the second concrete layer, a composite layer and/or the concrete cover layer, and the second handling unit being configured to arranging the positioning element and/or the reinforcement unit and/or for carrying out a smoothing and/or structuring method and/or for positioning further elements which may be part of the concrete component. The further elements can be, for example, stone slabs, which can be formed in particular for decorating the retaining wall.

The first handling unit and/or the second handling unit can be an articulated arm robot. Articulated arm robots have the advantage that they have a high kinematic flexibility and can thus arrange the concrete layers and the positioning element as well as the reinforcement unit in different layers.

A further preferred further development of the manufacturing system is characterized by a processing machine for contour-matched preforming and/or for dimensioning vertical reinforcement elements and/or horizontal reinforcement elements.

For further advantages, embodiment variants and embodiment details of the further aspects and their possible further embodiments, reference is also made to the previously given description regarding the corresponding features and further embodiments of the method for manufacturing a reinforced concrete component.

Preferred embodiments are explained by way of example with reference to the accompanying figures. They show:

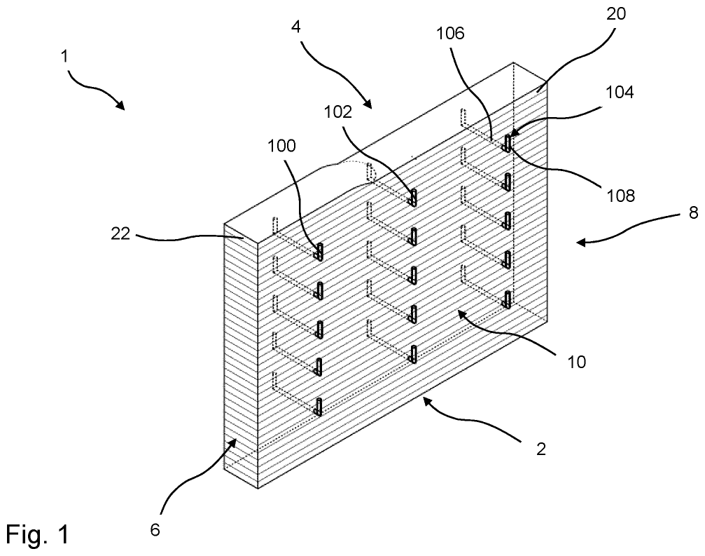

FIG. 1: a schematic, three-dimensional view of an exemplary embodiment of a reinforced concrete component;

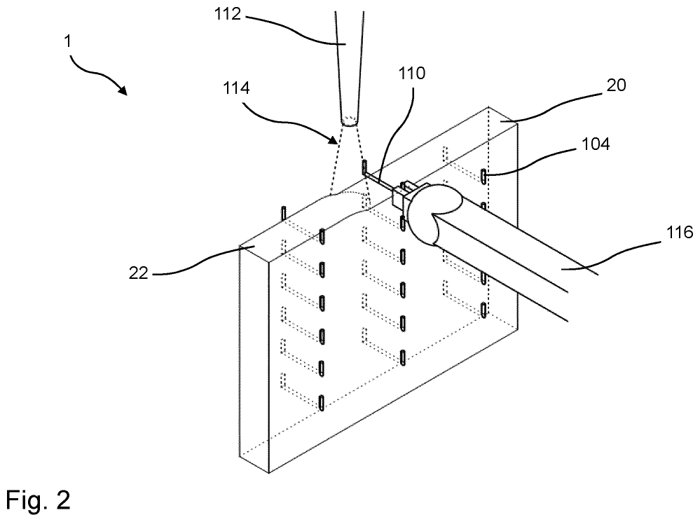

FIG. 2: a schematic, three-dimensional view of a manufacturing step of the reinforced concrete component;

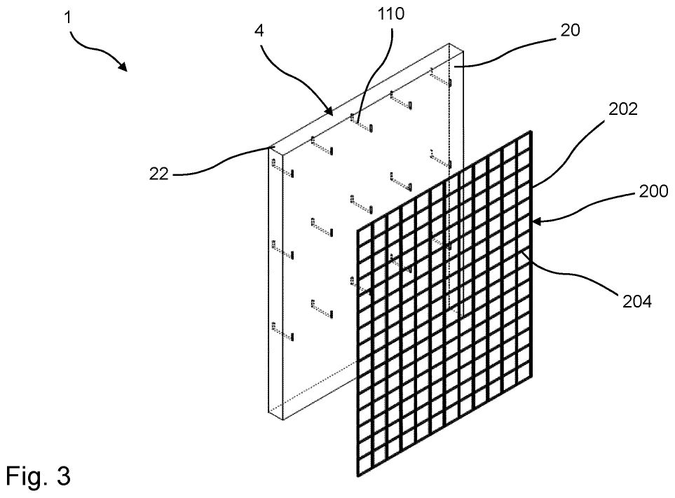

FIG. 3: a schematic, three-dimensional view of the concrete component with a reinforcement unit;

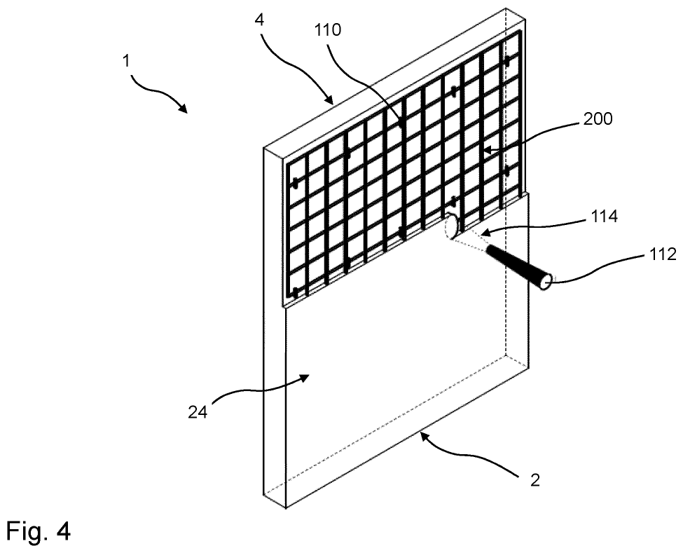

FIG. 4: a schematic, three-dimensional view of a manufacturing step of the reinforced concrete component;

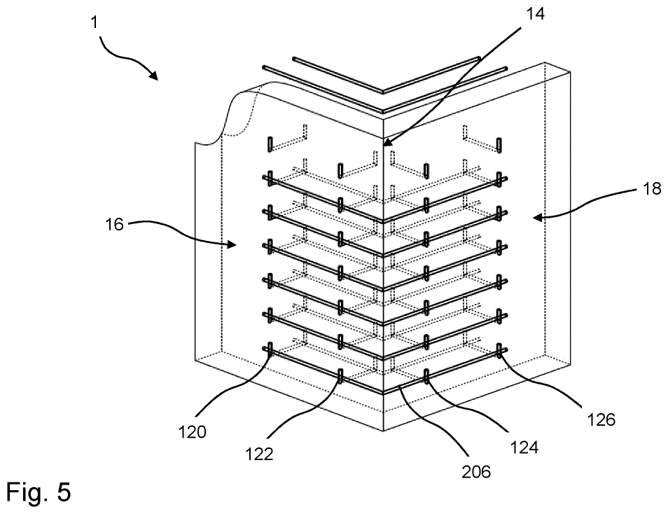

FIG. 5: a schematic, three-dimensional view of a corner area of the reinforced concrete component;

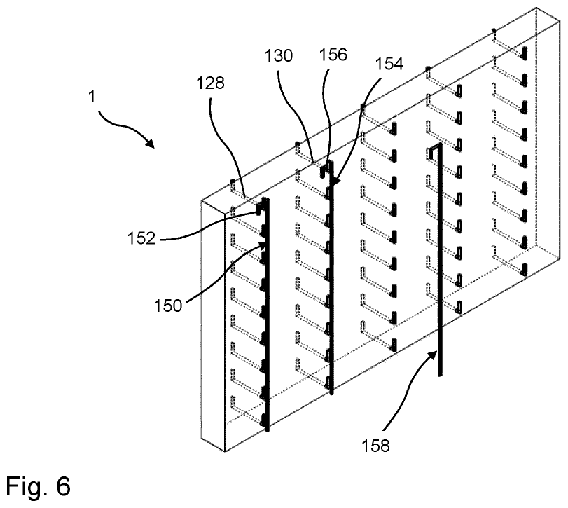

FIG. 6: a schematic, three-dimensional view of a manufacturing step of the reinforced concrete component;

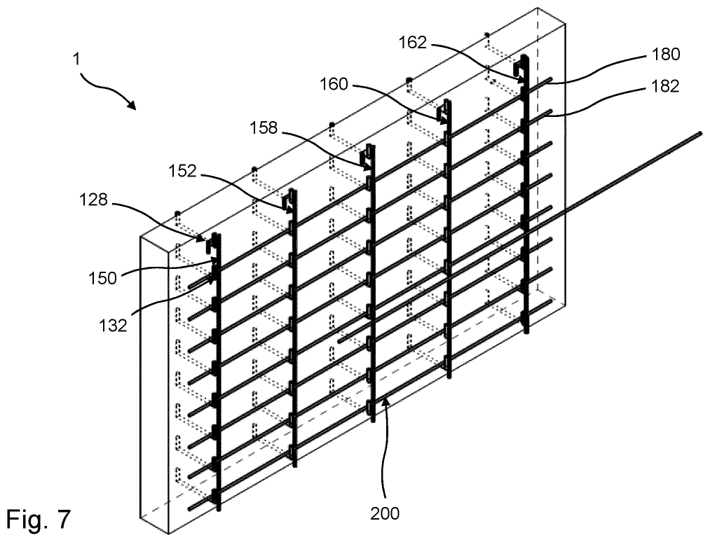

FIG. 7: another schematic, three-dimensional view of a manufacturing step of the reinforced concrete component;

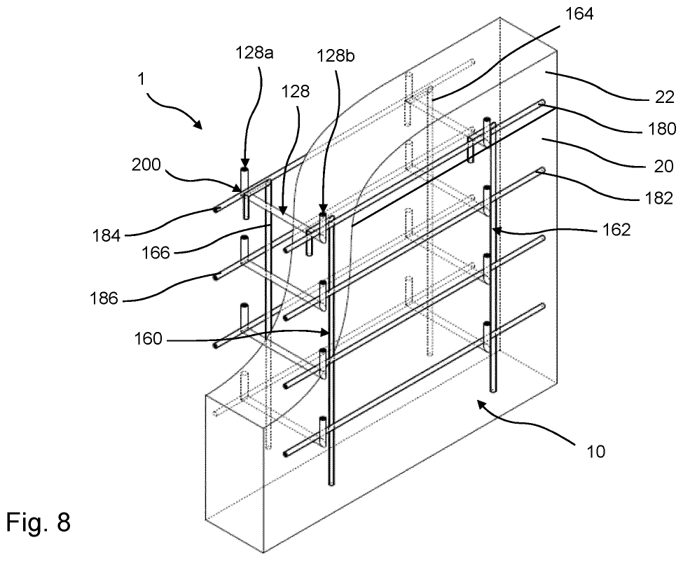

FIG. 8: a schematic, three-dimensional detailed view of a reinforced concrete component;

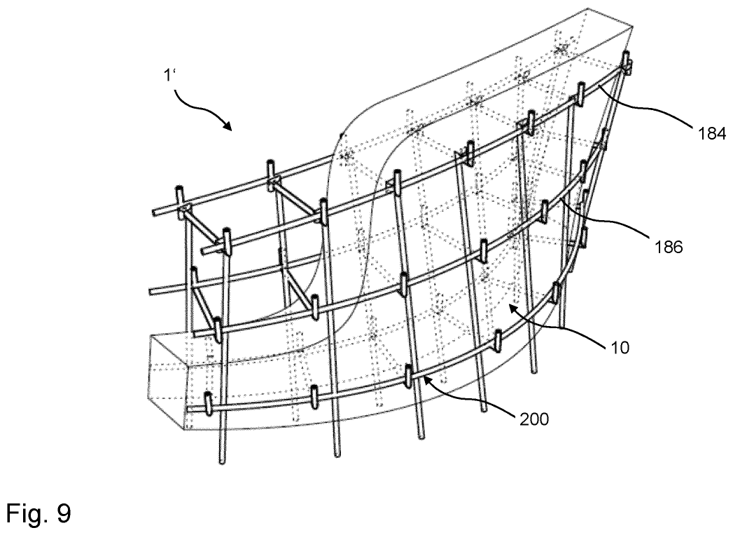

FIG. 9: another schematic, three-dimensional detailed view of the reinforced concrete component;

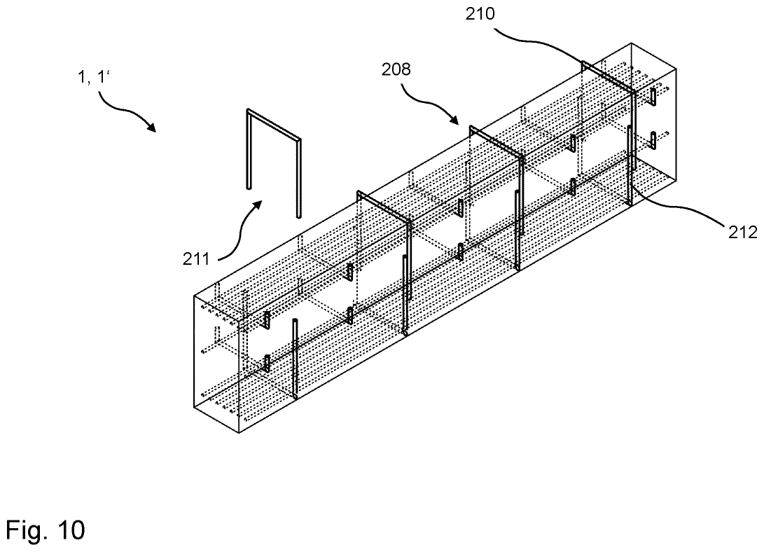

FIG. 10: another schematic, three-dimensional view of a reinforced concrete component with a shear reinforcement;

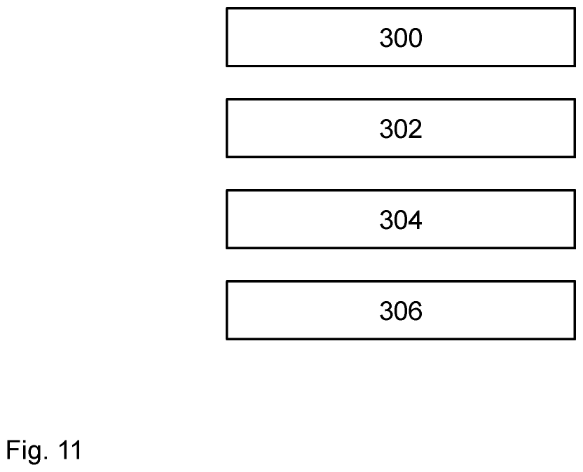

FIG. 11: a schematic process for the production of a reinforced concrete component;

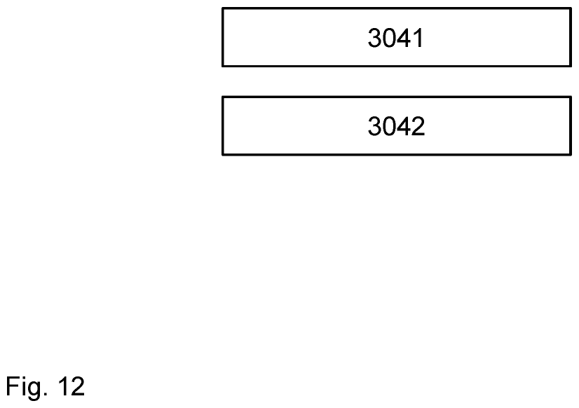

FIG. 12: a schematic view of a detail of the process shown in FIG. 11; and

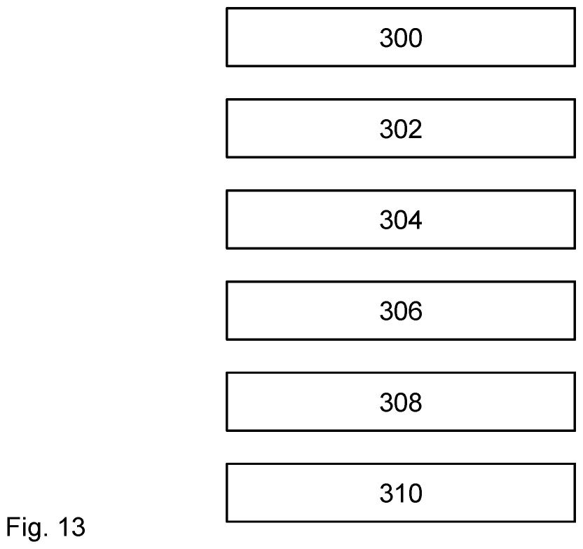

FIG. 13: a preferred embodiment of the process shown in FIG. 11.

In the figures, identical or essentially functionally identical or-similar elements are designated with the same reference signs.

FIG. 1 shows an intermediate step in the production of a reinforced concrete component 1. The reinforced concrete component 1 comprises a plurality of layers arranged one above the other. The concrete component 1 extends from a bottom side 2 to a top side 4, from a first front side 6 to a second front side 8, and from a first side surface 10 to a second side surface not shown, which is arranged opposite the first side surface 10.

Adjacent to the top side 4, the concrete component has a first concrete layer 20 and a not yet finished second concrete layer 22. Furthermore, positioning elements are arranged between the existing concrete layers at regular intervals spaced apart in the horizontal and vertical directions. The concrete component 1 has, among other things, the first positioning element 100, the second positioning element 102 and the third positioning element 104.

With reference to the third positioning element 104, a preferred geometry of the positioning elements is explained. The third positioning element 104 has a supporting section 106. The supporting section 106 is the section of the third positioning element 104 that is located between two adjacent layers of the concrete component 1. In addition to the supporting section 106, the third positioning element 104 comprises the fastening section 108. The fastening section 108 is to be distinguished from the supporting section 106 in that the fastening section 108 protrudes from the concrete layers. The positioning elements 100, 102, 104 are arranged and formed in particular in such a way that a reinforcement unit, explained in more detail below, can be arranged thereon.

In FIG. 2, the completion of the second concrete layer 22 is shown. Furthermore, the arrangement of a positioning element 110 is shown. By means of a handling tool 116, the fourth positioning element 110 is arranged on the first concrete layer 20. Subsequently, shotcrete 114 is applied to the first concrete layer 20 by means of the shotcrete nozzle 112. The shotcrete 114 forms the second concrete layer 22. As a result, the fourth positioning element 110 is located between the first concrete layer 20 and the second concrete layer 22.

FIG. 3 then shows the reinforcement step, namely that the reinforcement unit 200 is arranged with vertical reinforcement struts 202 and horizontal reinforcement struts 204 on the positioning elements. In particular, it is preferred that the reinforcement unit 200 is hooked to the uppermost row of positioning elements, which are thus adjacent to the upper side 4 in the vertical direction.

After the reinforcement unit has been arranged on the positioning elements 110, a concrete cover layer 24 can be applied with the shotcrete nozzle 112, as shown in FIG. 4. For this purpose, shotcrete 114 is applied in layers next to each other or over a wide area. Thus, the reinforcement unit 200 is embedded in concrete and can act as reinforcement and thus as a strengthening component of the concrete component.

FIG. 5 shows a reinforcement unit for a corner area. The corner area includes the first side 16 and the second side 18. The first side 16 and the second side 18 abut at the corner 14. On the first side 16, a fifth positioning element 120 and a sixth positioning element 122 are horizontally spaced apart, equally arranged in vertical height. The second side 18 has analogously arranged positioning elements 124, 126.

A corner reinforcement element 206 is disposed on the positioning members 120, 122, 124, 126. In particular, the corner reinforcement element 206 rests on the positioning elements 120, 122, 124, 126. This arrangement of the positioning elements and the corner reinforcement element in the corner area allows for automated reinforcement of corner areas.

FIGS. 6 to 9 show an addition or alternative to the reinforcement unit 200 shown in FIGS. 3 and 4. The reinforcement unit shown in FIGS. 3 and 4 is suitable for simple geometries to enable a cost-effective reinforcement strategy that can be easily automated. However, more complexly designed components in particular require a more flexible reinforcement concept.

In FIG. 6, it is shown that a first vertical reinforcement element 150, a second vertical reinforcement element 154 and a third vertical reinforcement element 158 are arranged at the positioning elements. For this arrangement of the vertical reinforcement members 150, 154, 158, the vertical reinforcement members each have a coupling section 152, 156. The coupling section 152, 156 each has a hook-shaped end. With this hook-shaped end, the vertical reinforcement elements 150, 154, 158 are arranged, in particular hooked, to the positioning elements 128, 130.

In FIG. 7, it is shown that a plurality of horizontal reinforcement elements 180, 182 are arranged next to the vertical reinforcement elements 150, 152, 158, 160, 162. In particular, it is preferred that the vertical reinforcement elements 150-162 are arranged first at the positioning elements and then the horizontal reinforcement elements 180, 182. Due to this sequence, the vertical reinforcement elements 150-162 are pressed against the concrete layers or in the direction of the concrete layers and the horizontal reinforcement elements 180, 182 can be clamped behind the hook-shaped end of the positioning elements. Thus, the vertical reinforcement elements 150-162 are also clamped. As a result, a reinforcement unit can be built up automatically, without manual effort, by means of vertical reinforcement elements and horizontal reinforcement elements, which furthermore is substantially positionally rigid due to the clamping effect and is substantially not moved by the creation of the concrete cover layer.

In FIG. 8, a detailed view of the reinforced concrete component 1 is shown. In particular, the positioning element 128 with two fastening sections 128 A, 128 B is shown here. The fastening sections 128a, 128b protrude from the concrete layers 20, 22 on opposite side surfaces 10. As a result, a reinforcement unit can be arranged on both side surfaces of the concrete component. In this case, the reinforcement unit is formed by the vertical reinforcement elements 160, 162 as well as the horizontal reinforcement elements 180, 182 and other reinforcement elements.

FIG. 9 shows a geometrically more complex concrete component 1′. The concrete component 1′ has a reinforcement unit 200 analogous to the component described in the previous, which is formed by means of horizontal and vertical reinforcement elements. The vertical reinforcement elements are substantially the same in this embodiment. If the concrete component 1′ has a more complex geometry, the vertical reinforcement elements may also differ. The horizontal reinforcement elements, on the other hand, are not straight bars, but are curved and, in particular, preformed. The horizontal reinforcement elements 184, 186 have a radius, wherein the radius can also change along the extension of the horizontal reinforcement element. It is particularly preferred that the preformed horizontal reinforcement elements 184, 186 are preformed to fit the contour in a previous process step. This upstream process step can also take place within the manufacturing system in which the concrete component 1′ is produced.

FIG. 10 shows another schematic, three-dimensional view of a reinforced concrete component 1,1′ with a shear reinforcement. The concrete component 1,1′ comprises a plurality of positioning elements which are designed as described above. In the present case, the shear reinforcement is formed as a strap reinforcement 208. The strap reinforcement 208 comprises a plurality of first straps 210 and a plurality of second straps 212. The straps 210, 212 have a U-shape. The first straps 210 have a vertically downward opening 211. The second straps 212 have a vertically upward opening. The straps 210, 212 enclose the core of the concrete component 1, 1′. A respective first strap 210 and a respective second strap 212 are arranged at a substantially equal position of the concrete component 1, 1′. The legs of the straps 210, 212 overlap at substantially the same position. The structural member shown in FIG. 10 preferably comprises one or more of the further reinforcements described in the foregoing.

FIG. 11 shows a schematic method for manufacturing a reinforced concrete component 1, 1′. In step 300, a first concrete layer 20 and a second concrete layer 22 are produced using a generative process, preferably a shotcrete process, in particular a shotcrete process.

In step 302, a positioning member 100, 102, 104, 110, 120, 122, 124, 126, 128, 130 is arranged for fixing a reinforcement unit 200, wherein the positioning member 100, 102, 104, 110, 120, 122, 124, 126, 128, 130 is arranged with a supporting section 106 between the first concrete layer 20 and the second concrete layer 22 and protrudes from the first concrete layer 20 and from the second concrete layer 22 with a fastening section 108. In particular, it is preferred that the step 302 occurs between the creation of the first concrete layer 20 and the creation of the second concrete layer 22.

In step 304, at least one reinforcement unit 200 for reinforcing the concrete component 1, 1′ is arranged on the positioning element 100, 102, 104, 110, 120, 122, 124, 126, 128, 130.

In step 306, a concrete cover layer 24 is created at the first concrete layer 20 and the second concrete layer 22 such that the reinforcement unit 200 is substantially covered with concrete.

Preferably, step 304 comprises substeps 3041, 3042 shown in FIG. 12. In step 3041, a vertical reinforcement element 150-166 having a coupling section 152, 156 is arranged on the positioning element. In step 3042, a horizontal reinforcement element 180, 182, 184, 186 is arranged on the positioning element 100, 102, 104, 110, 120, 122, 124, 126, 128, 130. In particular, it is preferred that step 3041 is performed before step 3042 so that the vertical reinforcement elements 150-166 are clamped between the concrete layers 20, 22 and the horizontal reinforcement elements 180, 182, 184, 186 so that a prestressed reinforcement unit 200 is formed.

FIG. 13 shows a preferred embodiment of the method shown in FIG. 11. In particular, in step 308, a composite layer is applied to the first concrete layer 20 and the second concrete layer 22 in such a way that the reinforcement unit 200 is positioned at least in sections by means of the composite layer. This positioning is to be understood in particular relative to the concrete layers 20, 22. The composite layer is preferably created, in particular applied, before the concrete cover layer 24 is created.

In step 310, a horizontal reinforcement element 180-186 and/or a vertical reinforcement element 150-166 is preformed to match the contour, so that these preferably correspond to a concrete component contour. In particular, step 310 is performed before step 304, preferably before step 300.

### REFERENCE SIGNS

1, 1′ Concrete component
2 bottom side
4 top side
6 first front side
8 second front side
10 side surface
14 corner
16 first side
18 second side
20 first concrete layer
22 second concrete layer
24 concrete cover layer
100 first positioning element
102 second positioning element
104 third positioning element
106 supporting section
108 fastening section
110 fourth positioning element
112 shotcrete nozzle
114 sprayed concrete
116 handling tool
120 fifth positioning element
122 sixth positioning element
124 seventh positioning element
126 eighth positioning element
128 ninth positioning element
130 tenth positioning element
132 eleventh positioning element
150 first vertical reinforcement element
152 first coupling section
154 second vertical reinforcement element
156 second coupling section
158 third vertical reinforcement element
160 fourth vertical reinforcement element
162 fifth vertical reinforcement element
164 sixth vertical reinforcement element
166 seventh vertical reinforcement element
180 first horizontal reinforcement element
182 second horizontal reinforcement element
184 third horizontal reinforcement element
186 fourth horizontal reinforcement element
200 reinforcement unit
202 vertical reinforcement strut
204 horizontal reinforcement strut
206 corner reinforcement element
208 strap reinforcement
210 first strap
211 opening
212 second strap

1. A method of manufacturing a reinforced concrete component, comprising:
manufacturing a first concrete layer and a second concrete layer using a generative process,
arranging a positioning member for arranging a reinforcement unit, wherein the positioning member is arranged with a supporting section between the first concrete layer and the second concrete layer and protrudes with a fastening section from the first concrete layer and from the second concrete layer,
arranging the reinforcement unit for reinforcing the concrete component on the positioning element, and
creating a concrete cover layer on the first concrete layer and the second concrete layer such that the reinforcement unit is substantially covered with concrete.

2. The method according to claim 1, wherein first the first concrete layer is produced, the positioning element is arranged on the first concrete layer, and the second concrete layer is produced on the first concrete layer and on the positioning element such that the positioning element is arranged between the first concrete layer and the second concrete layer.

3. The method according to claim 1, wherein the reinforcement unit is provided as a prefabricated reinforcement unit having a plurality of interconnected reinforcement elements.

4. The method according to claim 1, wherein a composite layer is applied to the first concrete layer and the second concrete layer such that the reinforcement unit is positioned at least in sections by way of the composite layer.

5. The method according to claim 1,
the reinforcement unit having a vertical reinforcement element, the method comprising: arranging the vertical reinforcement element with a coupling section on the positioning element, and/or
wherein the reinforcement unit comprises a horizontal reinforcement element, the method comprising the step of: arranging the horizontal reinforcement element on the positioning element, preferably in a vertical direction on the positioning element, and
wherein first the vertical reinforcement element is arranged on the positioning element and subsequently the horizontal reinforcement element is arranged on the positioning element in such a way that the vertical reinforcement element is arranged at least in sections, in particular with the coupling section, between the horizontal reinforcement element and the first concrete layer and/or the second concrete layer and/or the composite layer.

6. The method according to claim 1, wherein the reinforcement unit comprises a corner reinforcement element, the method comprising: arranging the corner reinforcement element in a corner area adjacent to a corner of the concrete component such that a first section of the corner reinforcement element is arranged on a first side of the concrete component at a first positioning element, and in that a second section of the corner reinforcement element is arranged on a second positioning element on a second side of the concrete component, which second side is different from and adjacent to the first side.

7. The method according to claim 1, comprising: contour-matching preforming the horizontal reinforcement element and/or the vertical reinforcement element, the horizontal reinforcement element and/or the vertical reinforcement element having a radius by the contour-matching preforming.

8. The method according to claim 1, comprising: finishing the concrete cover layer for smoothing and/or structuring.

9. A reinforced concrete component, comprising
a first concrete layer and a second concrete layer produced by a generative method,
a positioning member for arranging a reinforcement unit, which is arranged with a supporting section between the first concrete layer and the second concrete layer and which protrudes with a fastening section from the first concrete layer and from the second concrete layer,
the reinforcement unit arranged on the positioning element for reinforcing the concrete component, and
a concrete cover layer arranged on the first concrete layer and the second concrete layer such that the reinforcement unit is substantially covered by the concrete cover layer.

10. The reinforced concrete component according to claim 9,
wherein the reinforcement unit comprises a horizontal reinforcement element resting in a vertical direction on the positioning element, and/or
wherein the reinforcement unit comprises a vertical reinforcement element which is arranged with a coupling section, comprising a fastening hook, on the positioning element, and/or
wherein preferably the vertical reinforcement element is arranged at least in sections between the first concrete layer and/or the second concrete layer and/or a composite layer and the horizontal reinforcement element, wherein further the positioning element, the vertical reinforcement element and the horizontal reinforcement element are arranged and formed in such a way that a clamping acts between them.

11. The reinforced concrete component according to claim 9, wherein the reinforcement unit comprises a corner reinforcement element, wherein the corner reinforcement element is arranged in a corner area adjacent to a corner of the concrete component such that a first section of the corner reinforcement element is arranged on a first side of the concrete component at a first positioning element, and in that a second section of the corner reinforcement element is arranged at a second positioning element on a second side of the concrete component, which side is different from and adjacent to the first side.

12. The reinforced concrete component according to claim 9, wherein.
the fastening section of the positioning element is hook-shaped and/or loop-shaped, and/or the positioning element protrudes with a first fastening section on a first side of the concrete component and with a second fastening section on a second side of the concrete component opposite to the first side, and/or the positioning element has a main extension direction which is oriented substantially orthogonally to a layer thickness of the first concrete layer and/or the second concrete layer.

13. The reinforced concrete component according to any one of the preceding claims claim 9,
wherein the horizontal reinforcement element and/or the vertical reinforcement element is or are designed to match the contour and has or have a curved course, and/or
wherein the horizontal reinforcement element and/or the vertical reinforcement element is/are bar-shaped and preferably consists of steel or comprises steel.

14. A reinforcing structure for a reinforced concrete component, comprising
a positioning element for arranging a reinforcement unit, which
is with a supporting section disposable between a first concrete layer and a second concrete layer produced by a generative method, and
protrudes from the first concrete layer and from the second concrete layer by way of a fastening section, and
a reinforcement unit arranged on the positioning element for reinforcing the concrete component.

15. The reinforcement structure according to claim 14, wherein.
the reinforcement unit comprises a horizontal reinforcement element which rests in a vertical direction on the positioning element, and/or
the reinforcement unit comprises a vertical reinforcement element which is arranged with a coupling section, comprising a fastening hook, on the positioning element, and/or
the vertical reinforcement element is arranged at least in sections between the first concrete layer and/or the second concrete layer and/or a composite layer and the horizontal reinforcement element, wherein furthermore the positioning element, the vertical reinforcement element and the horizontal reinforcement element are arranged and formed in such a way that a clamping acts or can act between them.

16. A manufacturing system for manufacturing a reinforced concrete component, comprising
means, including a shotcrete nozzle, for manufacturing a first concrete layer and a second concrete layer using a generative method,
a handling system arranged and configured,
to arrange a positioning element for fixing a reinforcement unit between the first concrete layer and the second concrete layer,
to arrange a reinforcement unit on the positioning element, and the means, including the shotcrete nozzle, are adapted to produce a concrete cover layer on the first concrete layer and the second concrete layer such that the reinforcement unit is substantially covered with concrete.

17. The manufacturing system according to claim 16, wherein the handling system comprises a first handling unit and a second handling unit, wherein
the first handling unit comprises the means, including the shotcrete nozzle, for manufacturing the first concrete layer, the second concrete layer and/or the concrete cover layer, and
the second handling unit is configured to arrange the positioning element and/or the reinforcement unit, and comprises a handling tool.

18. The manufacturing system according to claim 16, comprising a processing machine for contour-matching preforming and/or for dimensioning vertical reinforcement elements and/or horizontal reinforcement elements.

19. The method according to claim 1, wherein the generative process comprises a shotcrete process.

20. The reinforced concrete component according to claim 9, wherein the first concrete layer and the second concrete layer are produced by a shotcrete method.
